(19) United States
(12) Patent Application Publication
(10) Pub. No.: US 2011/0145024 A1
(43) Pub. Date: Jun. 16, 2011

(54) COMPUTERIZED PLATFORM FOR SELLING TICKETS FOR SPORTING EVENTS THAT TAKE PLACE IN A STADIUM

(75) Inventors: Denis ADAMSKY, Moscow (RU); Yaniv OZANA, Ashkelon (IL); Oren TAL, Ashkelon (IL)

(73) Assignee: TICKET2FINAL LTD., Isle of Man (GB)

(21) Appl. No.: 12/972,706

(22) Filed: Dec. 20, 2010

Related U.S. Application Data
(63) Continuation-in-part of application No. 12/299,562, filed on Nov. 4, 2008, now abandoned.
(60) Provisional application No. 60/796,645, filed on May 1, 2006.

(51) Int. Cl. G06Q 10/00; G06Q 30/00

(52) U.S. Cl. 705/5

(57) ABSTRACT

A system for ordering tickets for sporting events that are taking place in a stadium is provided herein. In an early bird stage, a seat allocation function calculates an amount of seats in the stadium for each fan club and offers it as a service order. Parameters of the seat allocation function are constant and variable for each ticket order. A seat allocation is performed for each specified combination of the sporting event of the team that the fan admires versus other teams. The ticket order is provided as a service order to fans who wish to reserve a seat and to pay official price for the ticket in case the team the fan admires will play in the specified sporting event. A ticket is sold in an official price for every ticket service order, and seats for each fan club are being allocated in separate zones of the stadium.

### CROSS REFERENCE TO RELATED APPLICATIONS

The present application is a Continuation-In-Part application of National stage patent application Ser. No. 12/299,562 filed on Nov. 4 2008, which claims priority to International Patent Application No. PCT/IL2007/000513 filed on Apr. 26, 2007, which claims priority to U.S. Provisional Patent Application No. 60/796,645 filed on May 1, 2006.

### BACKGROUND

1. Field of Invention

This invention relates to a system and method for selling tickets for sporting events that are taking place in a stadium; and more particularly, to a system and method for selling tickets combining an early bird ticket order as a service order and formatting a separate section for each fan club in the stadium.

2. Description of Related Art

One of the most common issues for fans of a particular sports group, such as a basketball or a soccer team participating in a tournament, is the inability to know in advanced whether or not their team would play in a specified sporting event in a non-limiting example, a final game. By the time identity of participants in the final game is known, the tickets to the final game are sold out and fans have to pay skyrocket prices to holders of the tickets or to touts.

There are many different known ways to offer prospective buyers tickets to sporting events. One patented way is to reserve future purchases of goods or services using plural electronic options with associated option fees as read in European Patent Publication No. EP2225673A1: METHOD AND SYSTEM FOR RESERVING FUTURE PURCHASES OF GOODS OR SERVICES prior date 2007-12-21. However, the patented way of selling future purchases of goods or services is not customized to special needs of organizing bodies of sporting events taking place in stadiums.

The existing art may tackle some administrative issues such as how many seats should be allocated for fans of each team, the level of rivalry between the fans of opponent teams may require special security arrangements, the distance of origin location of fans from the stadium may influence on the demand for tickets and the like.

These administrative issues may get resolved, when the following decision-making information in an early stage of a season of sporting events, is provided: 1) Identity of the teams that will play in the sporting event is not known. 2) Level of traditional rivalry between the fans of the teams on final games. 3) The extent of attractiveness of the teams that reach the final game for prospective ticket-buyer 4) The distance between origin location of prospective ticket-buyers and the stadium where the sporting event is taking place.

The present invention provides a solution to the aforementioned decision-making information that is not known and may resolve administrative issues in the art.

Prior to setting forth the background of the related art, it may be helpful to set forth definitions of certain terms that will be used hereinafter.

The term “Sporting event” as used herein in this application, is defined as any sporting event specified by a fan.

The term “Stadium” as used herein in this application, is defined as any venue that is arranged for carrying out any sporting event.

The term “Final game” as used herein in this application, is defined as a single occasion or a definite portion of a sporting event.

### BRIEF SUMMARY

The present invention provides a system and methods for an early bird order of tickets for sporting events that are taking place in a stadium and formatting a section for fans of each team in the stadium.

In many sporting events the fans of the teams that played in the specified sporting event, in a non-limiting example, a final game, pay an exorbitant price when buying a ticket close to the date of the final game. The reason for the exorbitant price is that in most tournaments the demand for tickets exceeds the supply. When implementing the present invention the fans of the teams that will reach final games may be able to guarantee seats in the stadium in an official price.

An interaction between the rival teams in the stadium, during the sporting event, may lead to verbal and physical violence. The present invention may minimize the interaction between the rival teams and may contribute to the sense of belonging of the fans, by organizing the fans of each team in separate sections of the stadium.

In another aspect of the invention, options of tickets for the sporting events may be purchased when identity of participants in a specified sporting event, in a non-limiting example, a final game, is not known. The method that may implement this aspect comprises: sending purchasing option request by a fan of one of the teams via a communication network. The request may include an identification of at least one favorable participant. The option request is offered by a central computing system to the fan at a price which is lower than the ticket price at that time point. Further, fans who purchased the ticket options and their team is playing in the sporting event, may purchase tickets in an official price.

The calculation of the option price includes parameters such as: time period before the sporting event, as longer the time period the lower the price of the ticket option; prospects of popularity of the teams that will play in the sporting event, the higher the popularity the higher the price of the ticket option and many other parameters.

### BRIEF DESCRIPTION OF THE DRAWING

The drawings, not drawn to scale, include the following Figures:

FIG. 1: shows a graph of a price increase over time, according to existing art;

FIG. 2A shows an illustration of a stadium in which the seats for the fans of team A and the seats for the fans of team B are mixed in some zones, according to existing art;

FIG. 2B: shows an illustration of a stadium in which the seats of team A and team B are in Different Zones, according to some embodiments of the present invention;

FIG. 3: is a block diagram illustrating a process of ticket's order and seats allocation in the stadium, according to some embodiments of the invention, according to some embodiments of the present invention;

FIG. 4: shows a personalized ticket, according to some embodiments of the present invention; and

FIG. 5: is a flowchart illustrating another aspect of purchasing a ticket, according to some embodiments of the present invention.

### DETAILED DESCRIPTION OF INVENTION

For a better understanding of the invention and to show how the same may be carried into effect, reference will now be made, purely by way of example, to the accompanying drawings in which like numerals designate corresponding elements or sections throughout.

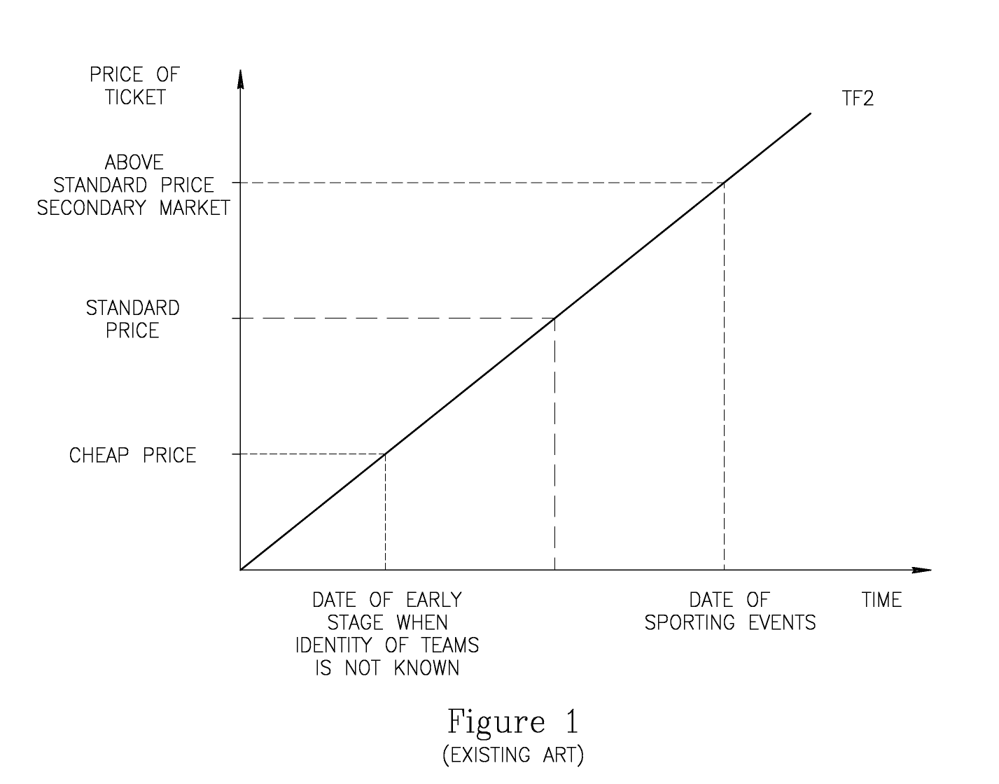

FIG. 1 shows a graph of a price increase over time, according to existing art. The graph shows a cheap price of a ticket in an early stage of a season of sporting events. In the early stage, the identity of the teams reaching and playing in a final game is not known. There is an increase in the price of the ticket over time.

As getting closer to the date of the final game, the price of the ticket exceeds an official price and the ticket is sold in an exorbitant price in legal market and secondary market, according to existing art.

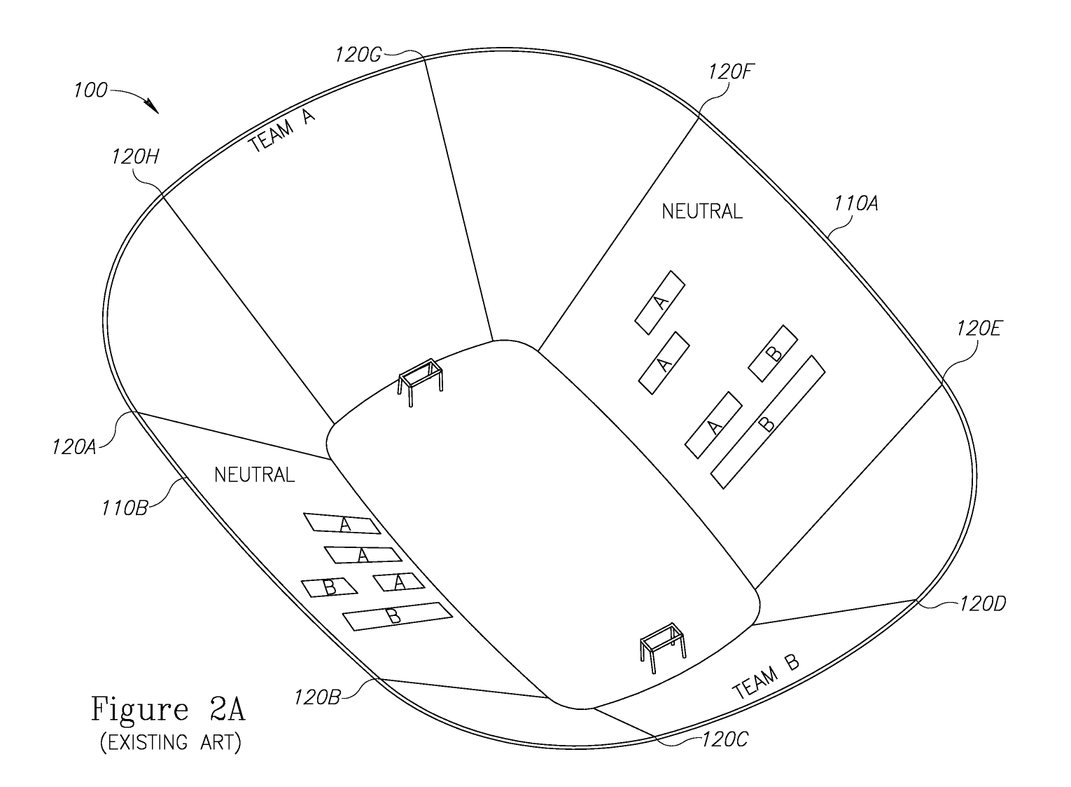

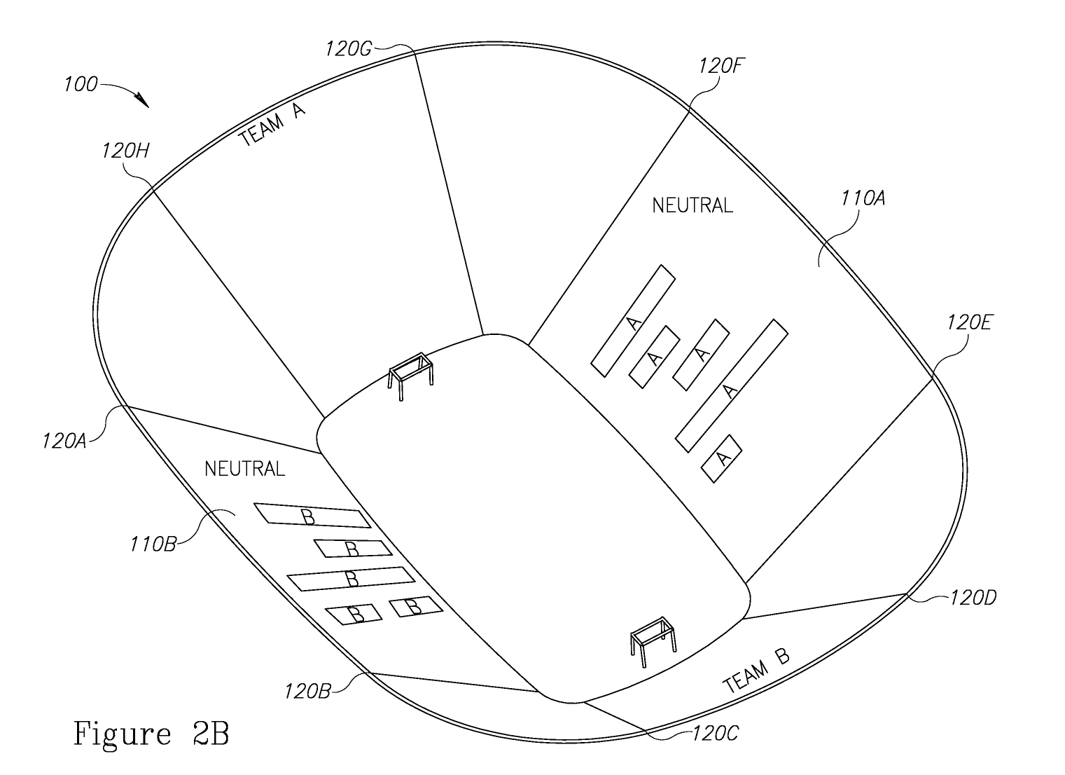

FIG. 2A: The Seats for Fans of Team A and Team B are Mixed in some zones in the Stadium.

FIG. 2A shows an illustration of a stadium in which the seats for the fans of team A and the seats for the fans of team B are mixed in some zones, according to existing art. Aisles 120A, 120B, 120C, 120D, 120E, 120F, 120G and 120H divide the stadium into zones. In zones 110A and 110B fans of team A sit close to fans of team B, according to existing art.

FIG. 2B: The seats for Fans of Team A and Team B are in Different Zones

FIG. 2B shows an illustration of a stadium in which the seats for fans of team A and the seats of fans of team B are in Different Zones. Aisles 120A, 120B, 120C 120D, 120E, 120F, 120G and 120H divide the stadium into zones, a result of some embodiments of the present invention.

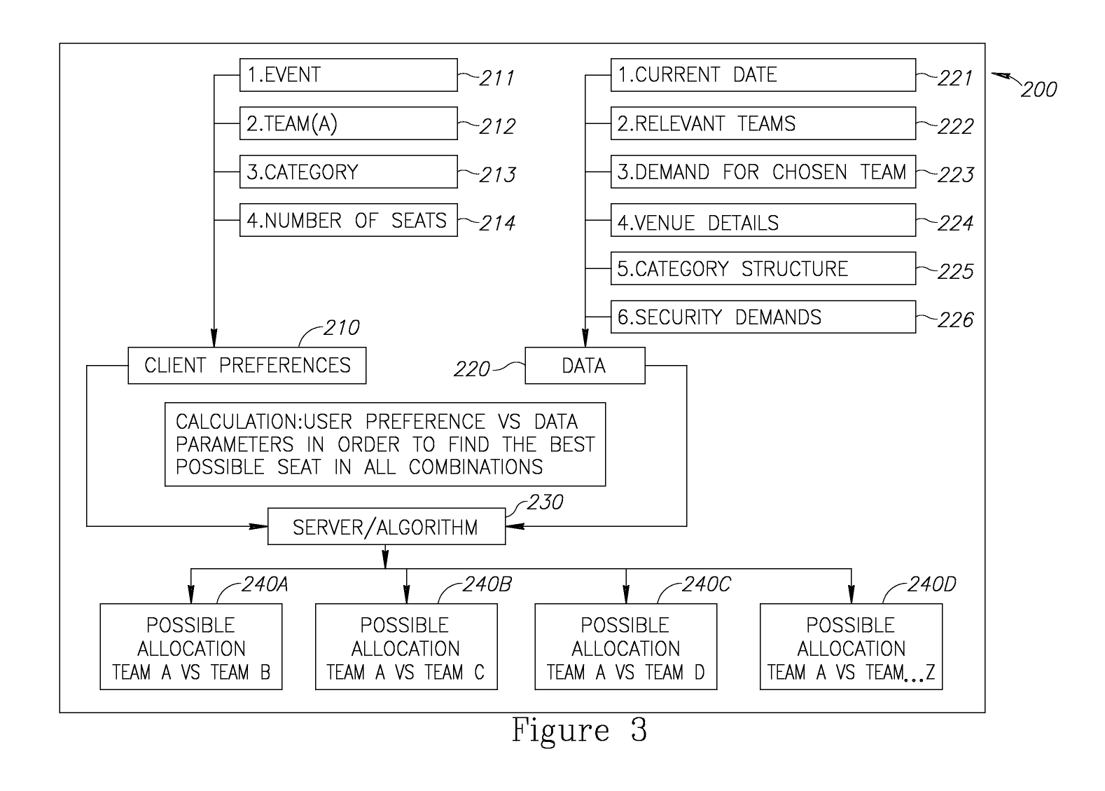

FIG. 3: A Process of Ticket's Order and Seats Allocation in the Stadium

FIG. 3 is a block diagram of a process of ticket's order and optimal seats allocation in the stadium, according to some embodiments of the invention.

An algorithm running on server 230 simulates all possible game combinations of teams playing in a specified sporting event, in a non-limiting example, a final game and reserves a variety of all possible allocations of seats in all game combinations of games 240A, 240B, 240C, 240D.

Preferences of prospective ticket-buyers 210 are taken as parameters into the algorithm running on server 230. The parameters are: event details 211, identity of team 212, category 213, and number of seats that needs to be reserved for the fans of the team 214.

Data parameters 220 are taken as parameters into the algorithm running on server 230. The parameters are: current date 221, relevant team 222, demand for chosen team 223, venue details 224, category structure 225 and security demands 226.

The algorithm that is running on server 230 in FIG. 3 performs an analysis of the zones in the stadium by the Aisles 120A, 120B, 120C 120D, 120E, 120F, 120G and 120H in FIGS. 2A and 2B. The analysis combines security demands 226 in FIG. 3 including general and specific demands. An example of a general security demand may be not mixing fans of different teams in specified zones in the stadium. An example of a specific demand may be that fans of a specific team may not sit in a zone next to fans of another team.

According to the analysis, the algorithm that is running on server 230 in FIG. 3 allocates a certain amount of tickets for the fans of each team in each game combination. The number of tickets per each group of fans is calculated based on constant and variable parameters.

An example of constant parameter that may be taken into account when calculating the number of tickets allocated per each group of fans is a number of potential fans that may be considered as prospective ticket-buyers. Another example of constant parameter is a distance of the stadium where the final game is taking place and the fans origin location. Yet another example of a constant parameter is the level of competiveness, i.e. traditional rivalry between two fan clubs.

An example of a variable parameter that may be taken into account when calculating the number of tickets that is allocated per each group of fans is the accomplishments of the team in a certain point in time. Fans are more likely to become ardent devotees and buy tickets to a final game when the team achieved high accomplishments, rather than the fans of a team with low achievements.

Another example of a variable parameter that may be taken into account when calculating the number of tickets that is allocated per each group of fans is drop of teams during a tournament.

Yet another example of a variable parameter that may be taken into account when calculating the number of tickets that is allocated per each group of fans is an injury or dereliction of a key player.

The algorithm that is running on server 230 in FIG. 3 allocates a seat in every game combination at the time a ticket is booked in the early bird stage. In case an allocation of a seat in one of the games combinations is not possible the order is listed under a waiting list and the pre-sale is stopped. The situation may change in the wake of one of the variable parameters hence the pre-sale may continue.

The algorithm that is running on server 230 in FIG. 3 may have the ability to respond to high demand of tickets of a certain fans club. The response may be an evacuation of a zone in favor of the fans club according to the other parameters.

The result of the usage of the algorithm that is running on server 230 in FIG. 3 is a separation of the two fan clubs by a placement in the stadium in different zones. Another result of the usage of the algorithm that is running on server 230 in FIG. 3 is an early bird ticket order as a service order to a final game in an early bird stage, without knowing the identity of the teams that will reach and play the final game.

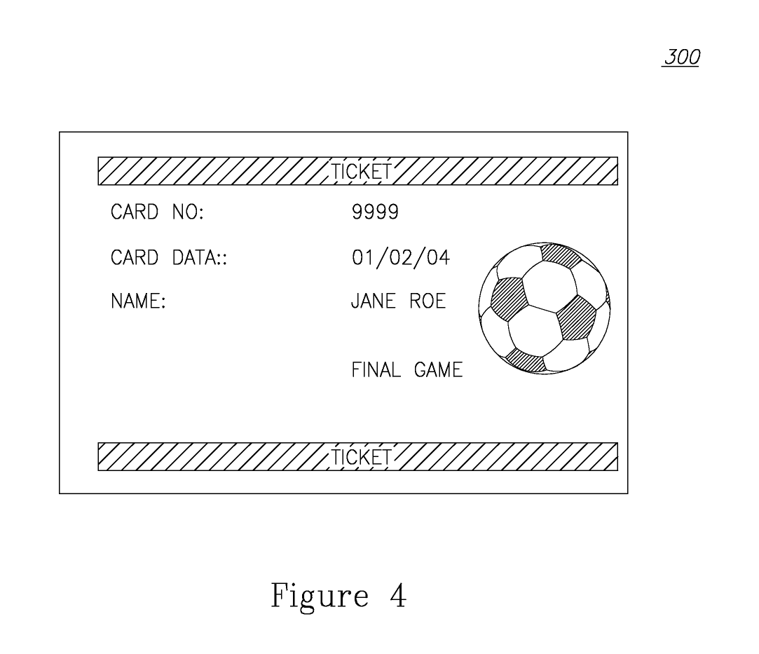

FIG. 4: shows a personalized ticket that may be sold for each buyer. The personalized ticket may include identification details of the buyer such as a name and a photo. These identification details may be used as security check in the entrance to an event taking place in a stadium.

Further, the personalized ticket may have a collection value to the fans.

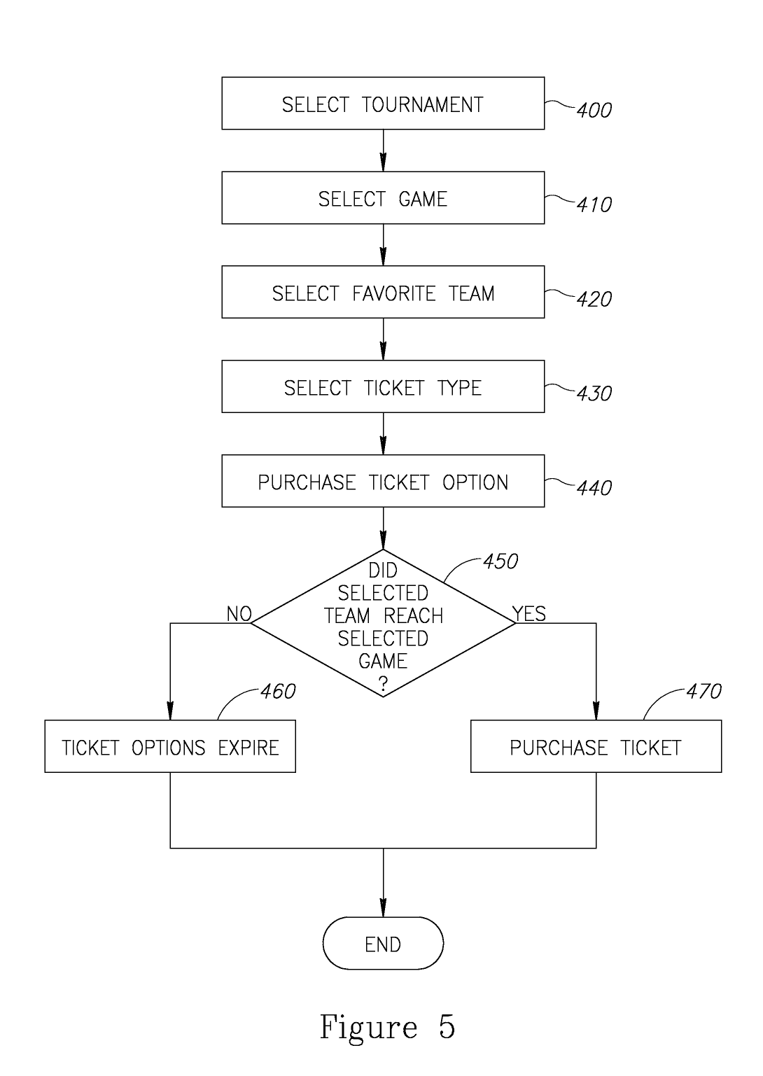

FIG. 5 is a flowchart illustrating another aspect of purchasing a ticket, according to some embodiments of the present invention. When a fan enters the system he is requested to select the tournament he wish to purchase a ticket to (step 400). Examples of tournaments: national leagues and national cup such as the English football league, the American National Basketball Association league, and the Euroleague. Then, the fan is requested to select a game, for example, semifinals or finals (step 410) and to indicate which team the fan wish to see (step 420). Then, a ticket type is selected (step 430), according to ticket prices rating. Then, options to tickets may be purchased (step 440).

As a season progresses and the identity of the teams that participate in the final games is known, the system checks for all buyers of the ticket options and selects the correct combination (step 450). Fans of the teams which participate in the final game may purchase tickets associated with already allocated seats (step 470), the ticket options of the buyers who didn't pursue a ticket expires (step 460).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of ordering tickets by a fan, in an early bird stage, for specified sporting events that are taking place in a stadium, comprising:
applying a seat allocation function configured to calculate, based on parameters, an amount of seats for each fan club in the stadium in the early bird stage, in response to a service order made by a fan specifying a team; and
generating a personalized ticket after a ticket purchase, wherein the ticket purchase only takes place after the teams participating in the specified sporting event are known,
wherein the parameters of the seat allocation function are constant and variable,
wherein an official price is charged for each service order, when the teams participating in the specified sport event are known,
wherein the seat allocation function allocates one or more seats for a ticket order for each game combination of the specified team and other teams, and
wherein that seat allocation function allocates seats for fans of different teams in separate zones of the stadium.

2. The method according to claim 1, wherein in the early stage the identity of the teams that will play in the sporting event is not known.

3. The method according to claim 1, wherein the constant parameters are stationary over time and include at least one of: preferences of ticket order and security demands of the stadium.

4. The method according to claim 1, wherein the variable parameters are varying over time and include at least one of: preferences of ticket order and security demands of the stadium.

5. The method according to claim 1, wherein the personalized ticket includes identification details of the fan.

6. The method according to claim 1, wherein the personalized ticket is generated in a specified format to distinguish it from fake tickets and include identification details.

7. The method according to claim 1, wherein the game combination is one of: an uncertain combination and certain combination.

8. A system for ordering tickets by a fan, in an early bird stage, for specified sporting events that are taking place in a stadium, the system comprising:
a seat allocation module configured to calculate, based on parameters, an amount of seats for each fan club in the stadium in the early bird stage, in response to a service order made by a fan specifying a team; and
a personalized ticket generating module configured to generate, after a ticket purchase, wherein the ticket purchase only takes place after the teams participating in the specified sporting event are known,
wherein the parameters of the seat allocation function are constant and variable,
wherein an official price is charged for each service order, when the teams participating in the specified sport event are known,
wherein the seat allocation function allocates one or more seats for a ticket order for each final game combination of the specified team and other teams, and
wherein that seat allocation function allocates seats for fans of different teams in separate zones of the stadium.

9. The system according to claim 8, wherein in the early stage the identity of the teams that will play in the sporting event is not known.

10. The system according to claim 8, wherein the constant parameters are stationary over time and include at least one of: preferences of ticket order and security demands of the stadium.

11. The system according to claim 8, wherein the variable parameters are varying over time and include at least one of: preferences of ticket order and security demands of the stadium.

12. The system according to claim 8, wherein the personalized ticket includes identification details of the fan.

13. The system according to claim 8, wherein the personalized ticket is generated in a specified format to distinguish it from fake tickets and include identification details.

14. The system according to claim 8, wherein the specified sporting event game combination is one of: uncertain combination and certain combination.
